(19) United States
(12) Patent Application Publication
(10) Pub. No.: US 2023/0139352 A1
(43) Pub. Date: May 4, 2023

(54) NUT AND/OR BOLT ROTATION INDICATOR

(71) Applicant: INUT SYSTEMS LTD, Staffordshire (GB)

(72) Inventor: Gary Broadfield, Staffordshire (GB)

(21) Appl. No.: 17/916,267

(22) PCT Filed: Mar. 31, 2021
(86) PCT No.: PCT/EP2021/058487

§ 371 Date: Sep. 30, 2022

(30) Foreign Application Priority Data
Apr. 2, 2020 (GB) 2004862.5

(51) Int. Cl. F16B 1/00; F16B 31/02

(52) U.S. Cl. CPC F16B 1/0071; F16B 31/02

(57) ABSTRACT

A system and method for monitoring rotation of a nut or bolt. The system comprises an indicator for mounting to the nut or bolt and which is configured to rotate with the nut or bolt. The system further comprises a detector configured to detect a rotational position of the indicator, and a transmitter (242) configured to transmit data indicative of the detected rotational position of the indicator.The method comprises mounting an indicator to the nut or bolt such that the indicator rotates therewith, detecting, by a detector, a rotational position of the indicator - (442), and transmitting, by a transmitter, data indicative of the rotational position of the indicator.

### TECHNICAL FIELD

The invention relates to systems for monitoring rotation of a nut or bolt. More specifically, the invention relates to (but need not be limited to) systems configured to detect loosening of a nut or bolt.

### BACKGROUND

The humble nut and bolt has been used for decades in order to fasten components together in a wide range of technical fields. Nuts or bolts (hereafter referred to simply as a nut) can however, progressively loosen over time, especially when exposed to environmental effects such as heat expansion and contraction, and vibration, or alternatively as a result of improper torqueing on installation.

The consequences of nuts loosening may be catastrophic. Typically, a visual inspection to check for loosening may be conducted. This can however be time consuming, especially where large numbers of nuts are utilised and/or nuts to be monitored are spread over a large area, for example in railways or the aviation industry. Monitoring nuts may also be expensive and/or logistically challenging, for example, when checking the nuts of offshore wind turbines. Additionally, relying on visual inspections leaves room for human error.

### SUMMARY

According to the invention in a first aspect, there is provided a system for monitoring rotation of a nut or bolt, the system comprising an indicator for mounting to the nut or bolt and configured to rotate therewith, a detector configured to detect a rotational position of the indicator, and a transmitter configured to transmit data indicative of the detected rotational position of the indicator.

Optionally, the transmitter is configured to transmit an alarm signal indicating a loose nut condition if the detected rotational position of the indicator exceeds a threshold.

Optionally, the detector is configured to detect a change in rotational position of the indicator, and wherein the transmitter is configured to transmit an alarm signal indicating a loose nut condition if the detected change in rotational position of the indicator exceeds a threshold.

Optionally, the system further comprises an actuator, wherein the detector is configured to detect a change in relative rotational position between the actuator and the detector.

Optionally, the detector comprises a sensor configured to detect a property of the actuator indicative of a relative direction and/or range of the actuator from the detector.

Optionally, the property comprises a strength and/or a pattern of a magnetic field.

Optionally, the actuator generates the magnetic field and optionally comprises a magnet.

Optionally, the indicator comprises one of the actuator and the detector.

Optionally, the other of the actuator and the detector is for mounting in a location adjacent to the nut or bolt and is configured not to rotate therewith.

Optionally, the other of the actuator and the detector is fixed relative to the nut or bolt.

Optionally, the indicator comprises the actuator.

Optionally, the detector comprises the transmitter.

Optionally, the indicator and the detector comprise alignment features configured to indicate positions of the actuator and the sensor.

Optionally, the alarm signal comprises identification data configured to identify the indicator and/or the detector.

Optionally, the alarm signal comprises location data indicative of a geographic location of the indicator and/or the detector.

Optionally, the system further comprises an auto-calibrator configured to determine the threshold based on an initial property of the actuator sensed by the sensor at the time of fitting the system.

Optionally, the system further comprises a locator configured to cooperate with the detector and/or the indicator to facilitate positioning and mounting of the detector in a predetermined orientation and/or range with respect to the indicator.

Optionally, the locator is configured to couple to the detector and/or indicator to facilitate positioning and mounting of the detector and decouple from the detector and/or indicator after positioning and mounting of the detector.

Optionally, the locator comprises a coupling feature configured to couple the detector thereto.

Optionally, the locator comprises a locating feature configured to engage at least a portion of the indicator, such that when the detector is coupled to the locator and the locating feature is engaged with the at least a portion of the indicator, the detector is positioned in the predetermined orientation and/or range.

Optionally, the locator comprises a release mechanism configured to decouple the detector and/or indicator from the locator after positioning and mounting of the detector.

According to the invention in a further aspect, there is provided a method for monitoring rotation of a nut or bolt, the method comprising mounting an indicator to the nut or bolt such that the indicator rotates therewith; detecting, by a detector, a rotational position of the indicator; and transmitting, by a transmitter, data indicative of the rotational position of the indicator.

Optionally, the method further comprises transmitting, by the transmitter, an alarm signal indicating a loose nut condition if the detected rotational position of the indicator exceeds a threshold.

Optionally, the detector is configured to detect a change in rotational position of the indicator, and the method further comprises transmitting, by the transmitter, an alarm signal indicating a loose nut condition if the detected change in rotational position of the indicator exceeds a threshold.

Optionally, detecting the rotational position of the indicator comprises sensing, by a sensor, a property of an actuator indicative of relative direction and/or range of the actuator from the detector.

Optionally, the property of the actuator comprises a strength and/or a pattern of a magnetic field of the actuator.

Optionally, the indicator comprises one of the actuator and the detector, and the method further comprises mounting the other of the indicator and the detector in a location adjacent to the nut or bolt such that it does not rotate therewith.

Optionally, the method further comprises determining the threshold based on an initial property of the actuator sensed by the sensor.

### BRIEF DESCRIPTION OF THE DRAWINGS

FIG. 1 shows an exemplary system for monitoring rotation of a nut and/or bolt;

FIG. 2 shows a schematic representation of an exemplary detector;

FIG. 3 shows a flow diagram of a method of monitoring rotation of a nut and/or bolt; and

FIG. 4 shows an exemplary system for monitoring rotation of a nut and/or bolt.

### DETAILED DESCRIPTION

Generally disclosed herein are exemplary systems for detecting rotation and/or loosening of a nut. The exemplary systems may detect rotation of the nut and be configured to transmit a signal, and/or data, indicative of a rotational position of the nut. Alternatively, or in addition, exemplary systems may be configured to transmit an alarm signal if the rotational position of the nut is indicative of a loose nut condition. For example, exemplary systems may be configured to transmit an alarm signal if a change in rotational position of the nut exceeds a threshold. The inventors have realised that providing systems that transmit an alarm signal when a loose nut condition is detected eliminates the need for time consuming, expensive and difficult visual inspections, which may also be prone to human error. Instead, it is only necessary to respond to the alarm signals. In exemplary systems, the signals transmitted may comprise identification data and/or location data to allow the location of the loose nut to be determined. This allows the loose nut to be directly located to be tightened/replaced.

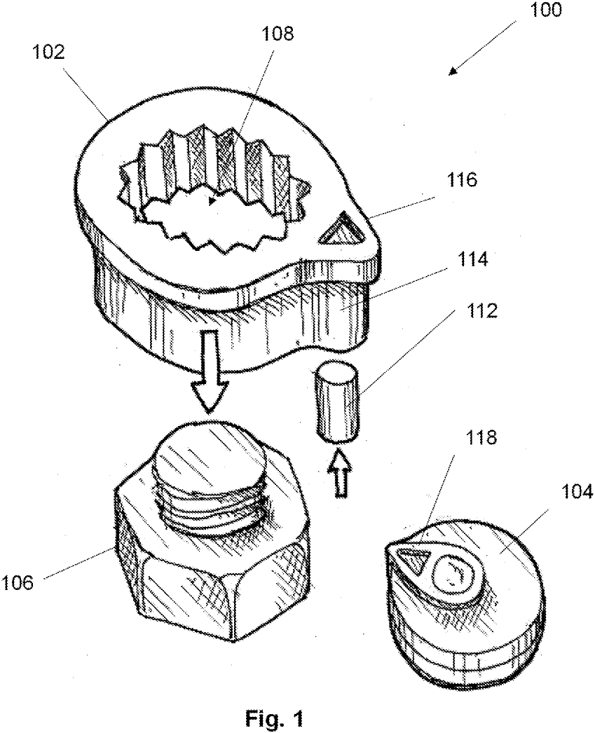

FIG. 1 shows an exemplary system 100 for monitoring rotation of a nut. The exemplary monitoring system 100 of FIG. 1 comprises an indicator 102 and a detector 104.

The indicator 102 is configured to be mounted to a nut 106. The indicator 102 may be configured to be mounted to the nut 106 such that the indicator 102 rotates therewith.

In the exemplary arrangement shown in FIG. 1, the indicator 102 comprises a collar comprising an aperture 108 configured to receive the nut 106. The aperture 108 may be dimensioned to provide an interference fit with the nut 106, such that the indicator 102 does not fall away from the nut 106 and may not be removed from the nut 106 without a force being applied. The skilled person will appreciate that alternative indicators may comprise a cap, cover or housing and may be configured to substantially enclose the nut 106. The skilled person will further appreciate that there are alternative ways of mounting the indicator 102 to the nut 106 such that the indicator 102 rotates therewith. For example, the indicator may be configured to be mounted to a surface of the nut, such as a sidewall or upper surface of the nut, such that the indicator rotates therewith. The skilled person will be able to envisage further arrangements.

The exemplary indicator 102 further comprises an indicator element 112. The indicator element 112 may be configured to rotate with the indicator 102. In exemplary arrangements, the indicator element 112 is fixed relative to the indicator 102.

In the exemplary arrangement of FIG. 1, the indicator element 112 is received within an aperture 114 of the indicator 102. In alternative arrangements, the indicator element 112 may be mounted to a surface of the indicator 102. For example, the indicator element 112 may be mounted to a sidewall, base or upper surface of the indicator 102.

The detector 104 may be configured to detect a property of the indicator element 112. The property of the indicator element 112 may be indicative of a direction of the indicator element 112 relative to the detector 104. Alternatively, or additionally, the property of the indicator element 112 may be indicative of a distance and/or range of the indicator element 112 from the detector 104. As will be described in more detail below, the detected property of the indicator element 112 may be used to determine whether the nut 106 has loosened (i.e. to determine whether there is a loose nut condition).

In Exemplary systems 100, the indicator element 112 may be configured to generate a magnetic field and may comprise a magnet. In exemplary arrangements, the indicator element 112 may comprise a permanent magnet. In such exemplary arrangements, the detector 104 may be configured to detect a strength and/or pattern of a magnetic field of the indicator element 112, as will be described in more detail below. In exemplary arrangements, the indicator element 112 may comprise a flat disc shape.

The skilled person will appreciate that in alternative arrangements, alternative indicator elements 112 may be used. For example, in alternative arrangements, the indicator element 112 may be configured to emit an electromagnetic field or, specifically, a radiofrequency (RF) field, and may comprise an electromagnetic field emitter or an RF emitter. In such arrangements, the detector may be configured to detect a strength of the electromagnetic or RF field of the indicator element. In further alternative arrangements, the indicator element may be configured to generate and/or reflect electromagnetic radiation, such as visible light. In such arrangements, the indicator element may comprise a surface configured to reflect the visible light or an electromagnetic radiation emitter, for example, one of an LED, a photodiode, a photodetector, and a light sensor. The detector may be configured to detect a strength of the electromagnetic radiation generated and/or reflected by the indicator element. The skilled person will be able to envisage further arrangements in which the indicator element emits and/or generates a wave, field strength or field pattern, or else comprises a property, which may be detected by the detector.

The exemplary indicator 102 of FIG. 1 further comprises an alignment feature 116. The alignment feature 116 may indicate a location of the indicator element 112. In the arrangement shown in FIG. 1, the alignment feature 116 comprises a radially extending protrusion. The alignment features 116 further comprises an indicia, which in the exemplary arrangement of FIG. 1 is located on a top surface of the indicator 102. The skilled person will appreciate that in alternative arrangements, alternative ways of providing an indication of the location of the indicator element may be used. For example, alternative arrangements may comprise an indicia located on substantially any surface of the indicator. In further alternative arrangements, the indicator element may be visible when the indicator is mounted to the nut, for example, the indicator may comprise a transparent portion through which the indicator element is visible. The skilled person will be able to envisage further arrangements.

In exemplary arrangements, the indicator 102 may be adjustable to accommodate a range of different sizes of nuts and bolts. In exemplary arrangements, the indicator 102 may be adjustable to vary the size of the aperture 108 configured to receive the nut 106. For example, the indicator 102 may comprise a clamp comprising opposed ends joined by a threaded bolt. The threaded bolt may be configured to alter the distance between the opposed ends and therefore alter the diameter of the aperture. Such an arrangement may be similar to an adjustable pipe clamp. The skilled person will be able to envisage further arrangements to achieve an adjustable indicator. Advantageously, this allows the indicator 102 to be used in different applications, which may use different nut/bolt sizes, without the need to custom make the indicator for each application.

The detector 104 may comprise a sensor 216 (not visible in FIG. 1) configured to sense a property of the indicator element 112, as described above. In exemplary systems, the sensor 216 may comprise a magnetic field sensor, such as a hall effect sensor configured to sense a magnetic field strength and/or pattern of a magnetic field generated by the indicator element 112. In alternative arrangements, the sensor 216 may comprise an electromagnetic field sensor or an RF sensor configured to sense a field strength of the electromagnetic or RF field generated by the indicator element 112. In further arrangements, the sensor 216 may comprise a photosensor configured to sense an amount of visible light reflected or generated by the indicator element 112.

As described in more detail below, the detector 104 may comprise further detector electronics. The detector electronics may be housed in a water-tight housing 120.

The detector 104 may further comprise an alignment feature 118. The alignment feature 118 may be configured to indicate a location of the sensor 216. The alignment feature 118 of the exemplary detector 104 of FIG. 1 comprises an indicia. The indicia of FIG. 1 is located on an upper surface of the detector 104, however the skilled person will appreciate that in alternative arrangements, the indicia may be located on substantially any surface of the detector. The skilled person will further appreciate that in alternative arrangements, alternative alignment features may be used, for example as mentioned above in respect of the alignment feature 116 of the indicator 102.

In exemplary arrangements, the detector 104 is configured for mounting in a location adjacent to the nut 106. For example, the detector 104 may be configured for mounting to a surface adjacent to the nut 106. In exemplary arrangements, the detector 104 may be configured for mounting adjacent to the nut 106 such that the detector does not rotate therewith.

In the exemplary arrangement shown in FIG. 1, the detector 104 may be mounted to a location adjacent to the nut 106 using an adhesive. The adhesive may comprise a double-sided tape. In alternative arrangements, the detector 104 may be mounted using alternative mounting means, comprising, for example, mechanical fasteners. In further alternative arrangements, the system 100 may further comprise a bracket configured to mount the detector 104 adjacent to the nut 106. The bracket may comprise a mounting plate configured to receive the detector and the mounting plate may be configured to be fastened to a surface adjacent to the nut to secure the detector 104.

In exemplary arrangements, the detector 104 and/or indicator 102 may further comprise a visual indicator (not shown in FIG. 1) configured to provide a visual indication if a loose nut condition is detected. The visual indicator may comprise an LED configured to illuminate if a property of the indicator element 112 sensed by the sensor 216 is indicative of a loose nut condition. In alternative arrangements, the detector 104 and/or indicator 102 may alternatively or additionally comprise an audible indicator configured to emit an audible alert if a loose nut condition is detected. The skilled person will appreciate that alternative indicators may be used to provide a short range indication that a loose nut condition has been detected. This may aid the on-site identification of the nut 106 to be tightened/replaced.

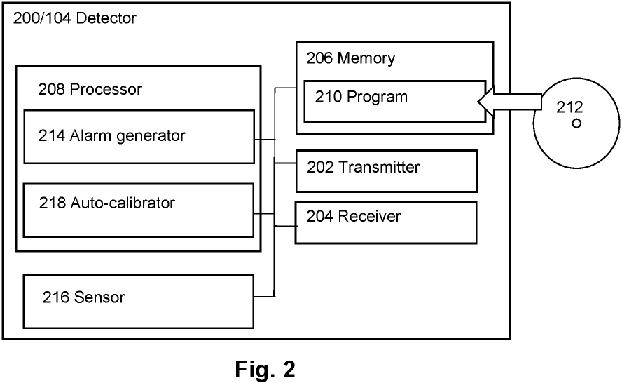

FIG. 2 shows a schematic representation of a detector 200, which may be the detector 104 shown in FIG. 1. The detector 200 comprises a transmitter 202 and may optionally comprise a receiver 204. In exemplary arrangement, the detector 200 may comprise an antenna, which may function as at least one of the transmitter and receiver. The transmitter 202 and/or receiver 204 may be in data communication with other entities, such as user equipment, servers and/or functions in a telecommunications network and are configured to transmit and receive data accordingly.

The detector 200 may further comprise a memory 206 and a processor 208. The memory 206 may comprise a non-volatile memory and/or a volatile memory. The memory 206 may have a computer program 210 stored therein. The computer program 210 may be configured to undertake the methods disclosed herein. The computer program 210 may be loaded in the memory 206 from a non-transitory computer readable medium 212, on which the computer program is stored. The processor 208 may be configured to undertake one or more of the functions of an alarm generator 214 and auto-calibrator 218, as set out below. The detector 200 also comprises a sensor 216 and the processor may be configured to control this feature.

Each of the transmitter 202, receiver 204, memory 206, processor 208, alarm generator 214, sensor 216 and auto-calibrator 218 may be in data communication with the other features 202, 204 206, 208, 210, 214, 216, 218 of the detector 200. The detector 200 can be implemented as a combination of computer hardware and software. In particular, the alarm generator 214 may be implemented as software configured to run on the processor 208. The memory 206 may store the various programs/executable files that are implemented by a processor 208, and also provides a storage unit for any required data. The programs/executable files stored in the memory 206, and implemented by the processor 208, can include the alarm generator 214 and auto-calibrator 218, but are not limited to such. The transmitter may use transmission frequency of, for example, one of 315 MHz, 433 MHz and 868 MHz.

Although not shown in FIGS. 1 or 2, exemplary detectors 104 may further comprise one or more of: a temperature sensor and vibration sensor. The temperature sensor may be configured to sense a temperature indicative of the temperature of an environment surrounding the nut 106. The vibration sensor may be configured to sense vibrations indicative of vibrations that the nut 106 is exposed to. As mentioned above, environmental effects such as heat expansion and contraction and vibration can lead to nuts loosening. In exemplary arrangements, the transmitter may be configured to transmit an alarm signal if a temperature condition is sensed by the temperature sensor indicative of adverse temperature conditions for the nut (e.g. a temperature that suggests loosening of the nut is likely). This may be a threshold temperature or a threshold rate of change of temperature. Similarly, the transmitter may be configured to transmit an alarm signal if a vibration condition is sensed by the vibration sensor indicative of adverse conditions for the nut (e.g. a vibration level or cycle that suggests loosening of the nut is likely). This may be a threshold vibration level or a threshold rate of change of vibration levels (e.g. a threshold number of vibration cycles).

The skilled person will appreciate that indicator 102 may comprise one or more features of the detector 104. For example, in exemplary arrangements, the indicator 102 may comprise the detector 104 and the indicator element 112 may be configured for mounting on a surface adjacent to the nut 106.

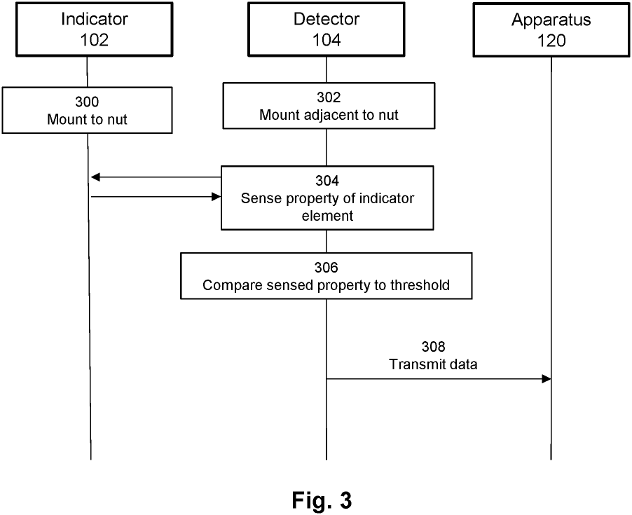

FIG. 3 shows a flow chart for a method for monitoring rotation of a nut.

In exemplary methods, the indicator 102 is mounted 300 to the nut 106. In exemplary arrangements, the nut 106 may be tightened to a desired torque before mounting the indicator 102 thereto. In the arrangement shown in FIG. 1, mounting the indicator 102 to the nut 106 comprises locating the indicator 102 over the nut 106 and applying a force to the indicator 102 such that the nut 106 is received in the aperture 108.

The indicator 102 may be mounted to the nut 106 such that relative rotation therebetween is prevented. As described above, relative rotation between the indicator 102 and the nut 106 may be prevented due to an interference fit between the aperture 108 of the indicator and the nut 106. In alternative arrangements, alternative means of preventing relative rotation between the indicator 102 and the nut 106 may be used. For example, an adhesive may be used to secure the indicator 102 to the nut 106.

The detector 104 may be mounted 302 in a location adjacent to the nut 106. In the arrangement shown in FIG. 1, the detector 104 is mounted such that it does not rotate with the nut 106. In exemplary arrangements, the detector 104 may mounted such that it is fixed relative to the nut 106. The skilled person will appreciate however that in alternative arrangements, the detector 104 may be mounted such that it is moveable relative to the nut 106. For example, the detector 104 may be mounted to a further nut, such that the detector 104 rotates with the further nut, wherein the further nut is adjacent to the nut 106 to which the indicator 102 is mounted. In such arrangements, rotation of either the nut 106 or the further nut will cause a change in proximity of the indicator element 112 relative to the detector 104.

In the exemplary arrangement of FIG. 1, the detector 104 may be mounted to a surface adjacent to the nut 106. The skilled person will appreciate that there are many ways of mounting the detector 104 to a surface adjacent to the nut 106, as described above. For example, the detector 104 may be secured to the surface adjacent to the nut 106 using an adhesive, fasteners or a mounting plate, for example.

The detector 104 may be mounted such that the sensor 216 is located adjacent to the indicator element 112. This may comprise mounting the detector 104 such that the alignment feature 118 of the detector 104 aligns with the alignment feature 116 of the indicator 102. In alternative arrangements, the detector 104 and the indicator 102 may be mounted in substantially any orientation, that is, in alternative arrangements, the alignment features 116, 118 may not align on mounting the detector 104 and the indicator 102.

The skilled person will appreciate that in alternative methods the detector 104 may be mounted at the location adjacent to the nut 106 before the indicator 102 is mounted to the nut 106. In such arrangements, the indicator 102 may be mounted to the nut 106 such that the alignment feature 116 of the indicator 102 aligns with the alignment feature 118 of the detector 104.

In exemplary arrangements, the detector 104 is configured to detect a rotational position of the indicator 102. The detector 104 may be configured to detect a rotational position of the indicator 102 by sensing 304 a property of the indicator element 112. Since the indicator 102 rotates with the nut 106, by detecting a rotational position of the indicator 102, rotation (and therefore loosening) of the nut 106 may be detected.

In the exemplary arrangement of FIG. 1, the detector 104 may be configured to sense a strength and/or a pattern of a magnetic field of the indicator element 112. The strength and/or pattern of the sensed magnetic field may be indicative of a distance between the detector 104 and the indicator 102. Specifically, the sensed strength and/or pattern of the magnetic field may be indicative of a distance (or a direction and/or range) between the indicator element 112 and the sensor 216. For example, as the nut rotates, the distance between the indicator element 112 and the sensor 216 may change. As such, the strength of the magnetic field sensed by the sensor 216 will also change, increasing as the distance between the sensor 216 and the indicator element 112 reduces, and decreasing as the distance between the sensor 216 and the indicator element 112 increases.

The sensor 216 may be configured to sense a property of the indicator element 112 at intervals. For example, the sensor 216 may be configured to sense the property of the indicator element 112 at intervals of 1 minute, 10 minutes, 1 hour, 24 hours and 48 hours. The skilled person will appreciate that the interval length may be varied based on application.

In alternative arrangements, in which the indicator element 112 may generate a signal for detection by the detector 104, the indicator element 112 may be configured to generate a signal at intervals. For example, the indicator element may comprise an RF emitter configured to emit a RF signal at intervals. The indicator element may be configured to generate a signal for detection by the detector at intervals of 1 minute, 10 minutes, 1 hour, 24 hours and 48 hours as above.

In exemplary arrangements, the sensor 216 may be configured to sense the property of the indicator element 112 at an increased sensing rate (that is, the interval length may be reduced) if adverse conditions for the nut are detected. For example, as mentioned above, exemplary arrangements may comprise a temperature sensor and/or a vibration sensor. In such arrangements, the sensing rate, and therefore the length of the interval, may be changed based on the temperature and/or vibration level detected by the temperature sensor and the vibration sensor. For example, the sensor 216 may be configured to sense the property of the indicator element 112 at an increased sensing rate (that is, the interval length may be reduced) if the vibration sensor detects adverse conditions for the nut (e.g. a vibration level or cycle that suggests loosening of the nut is likely). Similarly, the sensor 216 may be configured to sense the property of the indicator element 112 at an increased sensing rate (that is, the interval length may be reduced) if the temperature sensor detects adverse temperature conditions for the nut (e.g. a temperature that suggests loosening of the nut is likely).

In arrangements in which the indicator element 112 generates a signal for detection, the indicator element 112 may be configured to generate the signals for detection at an increased rate if adverse conditions for the nut are detected, as described above.

In exemplary arrangements, the transmitter 202 may be configured to transmit 308 data indicative of the sensed rotational position of the indicator 102. The data indicative of the sensed rotational position of the indicator 102 may comprise an absolute value of the property sensed by the sensor 216. As discussed above, the value of the property of the indicator element 112 sensed by the sensor 216 may be indicative of the distance between the indicator 102 and the detector 104.

The transmitter 202 may be further configured to transmit identification data configured to identify the indicator 102 and/or detector 104. Alternatively, or additionally, the transmitter 202 may be configured to transmit location data indicative of a geographic location of the indicator 102 and/or detector 104. This data may allow identification of the nut 106 to which the rotational position data relates.

In exemplary arrangements the transmitter 202 may be configured to transmit an alarm signal indicative of a loose nut condition. In such arrangements, the alarm signal may or may not comprise an absolute value sensed by the sensor 216.

In exemplary arrangements, the alarm generator 214 of the detector 104 may be configured to compare 306 a property of the indicator element 112 sensed by the sensor 216 with a threshold and determine whether an alarm signal should be generated based on the comparison. The threshold may be indicative of a loose nut condition. For example, the threshold may comprise a value of the property of the indicator element 112 that if sensed indicates that the rotational position of the indicator 102 suggests that the nut has loosened. If the sensed property is not outside of the threshold, then no alarm signal is generated and the property of the indicator element 112 is sensed again by the sensor 216 after the next interval period. If the alarm generator 214 determines that the sensed property is outside of the threshold then the alarm generator 214 generates an alarm signal indicating a loose nut condition and the transmitter 202 transmits the alarm signal.

In alternative arrangements, the alarm generator 214 may be configured to compare a property of the indicator element 112 sensed by the sensor 216 with a property of the indicator element previously sensed by the sensor 216. The alarm generator may be configured to generate an alarm signal for transmission if the property of the indicator element sensed by the detector differs from the previously sensed property by a threshold amount.

There are a number of ways to implement such alarms that will be known to the skilled person.

The alarm signal may comprise identification data and/or location data configured to identify the indicator 102 and/or the detector 104. As such, the nut 106 associated with the indicator 102 and/or the detector 104 may be identified by the alarm signal. This allows the nut 106 to be easily located and tightened/replaced.

In exemplary arrangements, the transmitter 202 may be configured to transmit the alarm signal to an apparatus 120. The apparatus 120 may be a user equipment, such as a mobile phone or other device. In exemplary arrangements, the user equipment may be configured to upload data indicating that an alarm signal has been received to a server. This may be a cloud-based server configured to transmit the indication that an alarm signal has been received to a further apparatus. For example, the further apparatus may be a further user equipment located in a control/maintenance centre.

The apparatus 120 may receive the alarm signal and indicate to a user that a loose nut condition has been detected. Alternatively, the apparatus 120 may be configured to transmit an indication that an alarm signal has been received to a further apparatus.

The alarm signal and the identification data and/or location data allow the nut 106 to be identified. As such, maintenance can travel directly to the location of the nut 106 and tighten/replace the nut 106 without the need to perform a visual check on every nut used in an assembly (e.g. ever nut in a section of railway track, or every nut on a wind turbine).

In exemplary arrangements, the apparatus 120 that received the alarm signal and/or data from the system 100 may be one of a plurality of ground receivers. The plurality of ground receivers may form a network. At least one of the ground receivers may be located near to the system 100. The data transmitted by the system 100 (and in exemplary arrangements, the transmitter 202 of the detector 104) may be transmitted between the network of ground receivers to boost the signal over large distances. In exemplary arrangements, the location of the system 100 may be determined based on the number of signals transmitted by the system 100 and received by a ground receiver directly. That is, the number of signals received by the ground receiver from the system 100, and not from a further ground receiver. This allows the ground receiver nearest to the relevant nut to be determined, and therefore the location of the relevant nut to be determined. In exemplary arrangements, at least one of the ground receivers may be battery and/or solar powered or mains powered.

As will be appreciated by the skilled person, in arrangements comprising the alignment features 116 and 118, as the nut 106 loosens and rotates, the alignment features 116 and 118 will be brought out of alignment. This allows a visual check to additionally be performed. This may aid the identification of the nut to be tightened/replaced in response to the alarm signal.

Once the nut has been tightened/replaced, the indicator 102 may be mounted to the tightened/new nut.

In exemplary arrangements, the detector 104 may comprise an auto-calibrator 218. The auto-calibrator 218 may be configured to calibrate the sensor 216. Calibrating the sensor 216 may comprise determining at least one threshold indicative of a loose nut condition. The at least one threshold may be determined based on an initially sensed property of the indicator element 112. For example, a property of the indicator element 112 sensed on fitting of the system 100.

The auto-calibrator 218 may be configured to calibrate the sensor 216 on installation of the system 100. In exemplary arrangements auto-calibration may occur when the detector 104 and the indicator 102 are brought within range of one another. For example, auto-calibration may occur when the indicator 102 and the detector 104 are mounted to the nut and a location adjacent to the nut. This may “wake up” the detector 104 which may initiate auto-calibration.

In exemplary arrangements, the threshold may be determined as a percentage of the initially sensed property of the indicator element 112, which may be the value of the property sensed on fitting the system 100. The threshold may be determined to be 25%, 50%, 100% or more of the initial sensed property. For example, in the exemplary arrangement of FIG. 1, the threshold may be determined as a percentage of the strength of the magnetic field sensed on fitting the system. Alternatively, the threshold may be calculated by adding or subtracting a predetermined absolute amount from the initial property sensed. The threshold may then be stored in the memory 206 of the detector for comparison with subsequently sensed properties of the indicator element 112. Advantageously, calibrating the sensor in such a way reduces the need for accurate alignment of the sensor and actuator on installation.

In alternative arrangements, the detector may not undergo a calibration process, and instead a manufacturer set threshold may be stored in the memory 206 of the detector 104.

The inventors have appreciated that installation of systems for monitoring rotation of a nut, such as the system described above, may be further simplified by facilitating accurate location of the indicator with respect to the detector on installation. In particular, installation may be further simplified by facilitating accurate location of the indicator element of the indicator with respect to the sensor of the detector. Exemplary systems may comprise a locator configured to interact with the detector and indicator to facilitate installation of the detector in a predetermined position with respect to the indicator. In exemplary systems the locator may also act as an applicator, allowing the user to pick up the detector and secure the detector to a surface in the predetermined position with respect to the indicator.

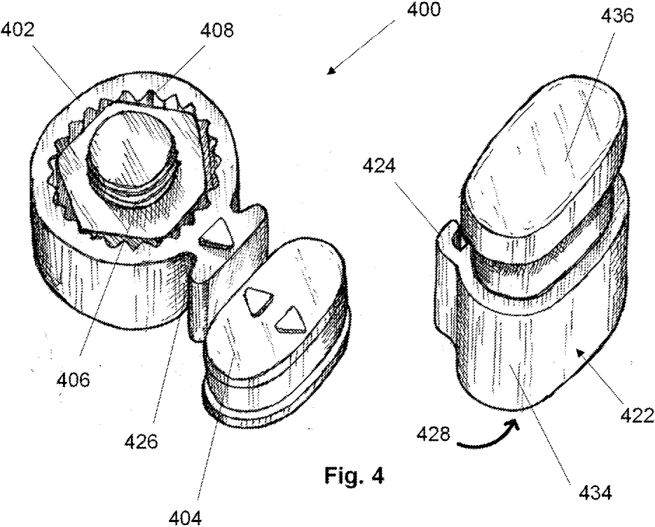

FIG. 4 shows a further exemplary system 400 for monitoring rotation of a nut. The exemplary monitoring system 400 of FIG. 4 comprises an indicator 402 and a detector 404. Many of the features of the indicator 402 and the detector 404 are similar to those described above in respect of the indicator 102 of FIG. 1 and the detector 104, 200 of FIGS. 1 and 2. As such, a description of these features is not given again here and corresponding reference numerals are used to identify them in FIG. 4. Thus, 412 is the indicator element (not visible in FIG. 4) and 408 is the aperture of the indicator 402, and 416 is the sensor of the detector 404.

The exemplary system 400 further comprises a locator 422. The locator 422 may be configured to cooperate with the detector 404 and/or indicator 402 to facilitate positioning and mounting of the detector 404 with respect to the indicator 402. The locator 422 may be configured to cooperate with the indicator 402 and/or the detector 404 to locate the detector 404 in a predetermined orientation and/or range of the indicator 402. In exemplary arrangements, the locator 422 may be configured to cooperate with the indicator 402 and/or the detector 404 to locate the sensor 416 of the detector 404 in a predetermined orientation and/or range of the indicator element 412 of the indicator 402. As will be described in more detail below, the locator 422 may be configured to engage with the detector to allow installation of the detector on a surface to which the detector is to be mounted in the predetermined orientation and/or range of the indicator 402.

In the exemplary arrangement of FIG. 4, the locator 422 comprises a locating feature 424. The locator 422 may comprise a coupling feature 428 configured to couple the detector 404 to the indicator 402.

The locating feature 424 of the locator 422 may be configured to cooperate with the indicator 402 to locate the detector 404 in a predetermined orientation and/or range of the indicator 402. In exemplary arrangements, the locating feature 424 of the locator 422 may be configured to cooperate with the indicator 402 to locate the coupling feature 428 (and therefore the detector 404, when the detector 404 is engaged with the coupling feature 428) in a predetermined orientation and/or range of the indicator 402

The locating feature 424 of the locator 422 may comprise a mechanical feature, such as a recess or a protrusion. In the exemplary arrangement shown in FIG. 4, the locating feature 424 comprises a keyed feature. The keyed feature of the locator 422 shown in FIG. 4 is configured to receive at least a portion of the indicator 402 therein. The skilled person will appreciate that in alternative arrangements, the indicator 402 may comprise the keyed feature and at least a portion of the locator 422 may be received therein.

In the exemplary arrangement of FIG. 4, the locating feature 424 of the locator 422 is configured to cooperate with a corresponding locating feature 426 of the indicator 402. The locating feature 426 of the indicator 402 may be indicative of a position of the indicator element 412 of the indicator 402. In exemplary arrangements, engagement of the locating feature 424 of the locator 422 and the locating feature 426 of the indicator 402 may align the indicator element 412 and the sensor 416 when the detector 404 is coupled to the locator 422.

The corresponding locating feature 426 of the indicator 402 may be received within the locating feature 424 of the locator 422. In the exemplary arrangement of FIG. 4, the corresponding locating feature 426 of the indicator 402 comprises a protrusion. The protrusion may be configured to be received within the keyed feature of the locator 422. In the exemplary arrangement of FIG. 4, the shape of the keyed feature of the locator 422 corresponds to the shape of the protrusion of the indicator 402.

The locator 422 may be configured to couple to the detector 404. In exemplary arrangements, the locator 422 may couple to the detector 404 such that movement of the locator 422 causes corresponding movement of the detector 404 (and vice versa).

The locator 422 may comprise a coupling feature 428 configured to couple the detector 404 to the locator 422. In exemplary arrangements the detector 404 may be positioned in the predetermined orientation and/or range of the indicator 402 when the locating features 424, 426 of the locator 422 and the indicator 402 respectively cooperate, and when the detector 404 is coupled to the locator 422.

In the exemplary arrangement shown in FIG. 4, the coupling feature 428 comprises a recess configured to receive at least a portion of the detector 404 therein. The recess may be sized and shaped such that when the detector 404 is received therein, it is retained within the recess due to a friction fit. The detector 402 may be configured to provide a poka-yoke fit within the recess of the locator 422. The poka-yoke fit may cause the detector 404 to be coupled to the locator 422 such that the sensor 416 of the detector 404 is positioned in a predetermined orientation with respect to the locating feature 424 of the locator 422. In turn, this causes the sensor 416 to be positioned in a predetermined position with respect to the indicator element 412 of the indicator 402 when the locator 422 is used to position and mount the detector 404.

The skilled person will appreciate that in alternative arrangements, alternative coupling features may be used. For example, the coupling feature of the locator 422 may comprise an adhesive configured to adhere to a surface of the detector 404. In further alternative arrangements, the coupling feature 428 may comprise a recess or protrusion configured to engage a corresponding recess or protrusion on the detector 404 to couple the detector thereto. In further alternative arrangements, the coupling feature may comprise a locating feature, similar to the locating feature 424 described above, but configured to cooperate with at least a portion of the detector 404. In further alternative arrangements, the coupling feature may comprise an abutment surface and the detector 404 may be configured to contact the abutment surface when the locator 422 is engaged with the indicator 402 to position the detector 404 correctly with respect to the indicator 402. The skilled person will be able to envisage other arrangements for coupling the detector 404 and the locator 422.

The locator 422 may be configured to releasably couple to the detector 404. The exemplary locator 422 shown in FIG. 4 comprises a release mechanism 430. The release mechanism 430 may be configured to decouple the detector 404 from the locator 422. In exemplary arrangements, the release mechanism 430 may be configured to decouple the detector 404 from the coupling feature 428 of the locator 422. The release mechanism 430 may act to decouple the detector 404 from the locator 422 and apply the detector 404 to the surface to which it is to be mounted.

The release mechanism 430 of the exemplary locator 422 shown in FIG. 4 comprises a first portion 434 and a second portion 436. The first and second portions 434, 436 may be axially moveable with respect to each other. In the exemplary arrangement shown in FIG. 4, the first portion comprises the locating feature 424 and the coupling feature 428. The second portion may be telescopically received within the first portion 434.

The second portion 436 may be configured to interact with the detector 404 when the detector 404 is coupled to the locator 422, such that relative axial movement between the first portion 434 and the second portion 436 decouples the detector 404 from the locator 422. In the exemplary arrangement shown in FIG. 4, an abutment surface of the second portion 436 may be configured to abut a surface of the detector 404 such that relative axial movement between the first portion 434 and the second portion 436 disengages the detector 404 from the recess of the locator 422.

Installation of the detector 404 using the locator 422 is described below with reference to FIG. 4.

The indicator 402 is mounted to the nut 406, similarly to as described above in respect of FIG. 3. As described above, the locating feature 426 of the indicator 402 may correspond to the position of the indicator element 412 of the indicator 402.

The locator 422 may be coupled to the detector 404. In exemplary methods, the locator 422 may be coupled to the detector 404 by engaging the coupling feature 428 with at least a portion of the detector 404. In the exemplary arrangement shown in FIG. 4, engaging the coupling feature 428 with the detector 404 comprises receiving the detector 404 within the recess of the locator 404. The user may push the locator 422 over the detector 404 such the detector 404 is received within the recess.

Once the locator is coupled to the detector 404, movement of the locator 422 causes corresponding movement of the locator 422. The locator 422 and the detector 404 may therefore be moved towards the installation site adjacent to the nut 406.

The locating feature 424 of the locator 422 may be engaged with the corresponding locating feature 426 of the indicator 402. This may comprise sliding the keyed feature of the locator 422 over the protrusion of the indicator 402 until the detector 404 contacts the surface to which it is to be mounted. In this position, the detector 404 is positioned in the predetermined orientation and/or range of the indicator 402. Specifically, the sensor 416 of the detector 404 is positioned in the predetermined orientation and/or range of the indicator element 412.

In exemplary arrangements, the detector 404 may be secured to the surface to which it is to be mounted using an adhesive. For example, the detector 404 may comprise a double sided tape. The pressure applied to the detector 404 via the locator 422 when engaging the locator 422 and the indicator 402 may adhere the detector 404 to the surface.

The locator 422 may be decoupled from the detector 404 and disengaged from the indicator 402 once the detector 404 is positioned (and in some arrangements, once the detector 402 has been secured to the surface).

Decoupling the detector 404 and indicator 402 from the locator 422 may comprise applying a force to the locator 422 to overcome the friction fit between the locator 422 and the detector 404.

In the exemplary arrangement of FIG. 4, the detector 404 may be decoupled from the locator 422 and secured to the surface to which it is to be mounted using the release mechanism 430. In the exemplary arrangement of FIG. 4, the abutment surface of the second portion 436 is brought into contact with the detector 404. This may comprise moving the second portion 436 with respect to the first portion 432 until the abutment surface of the second portion 436 contacts the detector 404. By applying pressure to the second portion 436 once the abutment surface is in contact with the detector 404, the axial position of the second portion 436 and the detector 404 is fixed.

The first portion 434 may then be moved axially with respect to the detector 404 (and with respect to the second portion 436) until the first portion 434 disengages from the detector 404. In the exemplary arrangement of FIG. 4, the first portion 434 disengages from the detector 404 once the detector 404 exits the recess. Once the detector decouples from the locator 422, the locator 422 may be removed, leaving the detector 404 mounted to the surface in the predetermined position and/or orientation with respect to the indicator 402.

The skilled person will appreciate that in alternative arrangements and methods, the locator may not comprise a second portion 436. In such arrangements, the first portion 432 may be decoupled from the detector 404 by the user applying a force directly to the detector 404 (for example, using a hand) and then sliding the first portion 436 off of the detector 404.

Decoupling the detector 404 and the locator 422 may simultaneously disengage the locator 422 and the indicator 402. In the exemplary method described above, the locating features 424, 426 may be disengaged as a result of the axial movement of the first portion 434 with respect to the detector 404.

The skilled person will appreciate that the above-described locator 422 enables accurate placement of the detector 404 with respect to the indicator 402, and specifically, the sensor 416 of the detector 404 with respect to the indicator element 412. The locator 422 provides a further advantage of allowing a detector to be moved and secured to a surface without the user having to directly touch the detector. In applications in which the detector comprises an adhesive to secure the detector to a surface, this is particularly advantageous since this ensures that there is no human contamination of the adhesive as a result of accidental contact with the adhesive. The detector may, for example, be provided on a reel of tape (for example where the adhesive is a double sided tape), and the locator allows the detector to be picked off of the tape and mounted to the surface without the user having to touch any component other than the locator.

A computer program may be configured to provide any of the above described methods. The computer program may be provided on a computer readable medium. The computer program may be a computer program product. The product may comprise a non-transitory computer usable storage medium. The computer program product may have computer-readable program code embodied in the medium configured to perform the method. The computer program product may be configured to cause at least one processor to perform some or all of the method.

Various methods and apparatus are described herein with reference to block diagrams or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

Computer program instructions may also be stored in a computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/Blu-ray).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

Accordingly, the invention may be embodied in hardware and/or in software (including firmware, resident software, micro-code, etc.) that runs on a processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated.

The skilled person will be able to envisage other embodiments without departing from the scope of the appended claims.

1. A system for monitoring rotation of a nut or bolt comprising:
an indicator for mounting to the nut or bolt and configured to rotate therewith;
a detector configured to detect a rotational position of the indicator, and
a transmitter configured to transmit data indicative of the detected rotational position of the indicator.

2. A system according to claim 1, wherein the transmitter is configured to transmit an alarm signal indicating a loose nut condition if the detected rotational position of the indicator exceeds a threshold.

3. A system according to claim 1, wherein the detector is configured to detect a change in rotational position of the indicator, and wherein the transmitter is configured to transmit an alarm signal indicating a loose nut condition if the detected change in rotational position of the indicator exceeds a threshold.

4. A system according to claim 1, further comprising an indicator element, wherein the detector is configured to detect a change in relative rotational position between the indicator element and the detector.

5. A system according to claim 4, wherein the detector comprises a sensor configured to detect a property of the indicator element indicative of a relative direction and/or range of the actuator from the detector.

6. A system according to claim 5, wherein the property comprises a strength and/or a pattern of a magnetic field
wherein the property comprises a stretch and/or a pattern of a magnetic field, and wherein the indicator element generates the magnetic field and comprises a magnet.

7. (canceled)

8. A system according to claim 4, wherein the indicator comprises one of the indicator element and the detector, or
wherein the indicator comprises one of the indicator element and the detector, and wherein the other of the indicator element and the detector is for mounting in a location adjacent to the nut or bolt and is configured not to rotate therewith.

9. (canceled)

10. A system according to claim 8, wherein the other of the indicator element and the detector is fixed relative to the nut or bolt.

11. A system, according to claim 8, wherein the indicator comprises the indicator element, or
wherein the indicator com prises the indicator element, and wherein the detector comprses the transmitter.

12. (canceled)

13. A system according to claims 5 , wherein the transmittter is configured to transmit an alarm signal indicating a loose nut condition if the detected rotational position of the wherein the indicator and the detector comprise alignment features configured to indicate positions of the actuator and the sensor.

14. A system according to claims 2, wherein the alarm signal comprises identification data configured to identify the indicator and/or the detector, or
wherein the alarm signal comprises identification data configured to identify the indicator and/or, the detector, and wherein the alarm signal comprises location data indicative of a geographic location of the indicator and/or the detector.

15. (canceled)

16. A system according to claim 4, further comprising an auto-calibrator configured to determine the threshold based on an initial property of the actuator sensed by the sensor at the time of fitting the system.

17. A system according to claim 1, further comprising a locator configured to cooperate with the detector and/or the indicator to facilitate positioning and mounting of the detector in a predetermined orientation and/or range with respect to the indicator.

18. A system according to claim 17, wherein the locator is configured to couple to the detector and/or indicator to facilitate positioning and mounting of the detector and decouple from the detector and/or indicator after positioning and mounting of the detector.

19. A system according to claim 17, wherein the locator comprises a coupling feature configured to couple the detector thereto.

20. A system according to claim 18, wherein the locator comprises a locating feature configured to engage at least a portion of the indicator, such that when the detector is coupled to the locator and the locating feature is engaged with the at least a portion of the indicator, the detector is positioned in the predetermined orientation and/or range.

21. A system according to claims 18, wherein the locator comprises a release mechanism configured to decouple the detector and/or indicator from the locator after positioning and mounting of the detector.

22. A method for monitoring rotation of a nut or bolt comprising:
mounting an indicator to the nut or bolt such that the indicator rotates therewith;
detecting, by a detector, a rotational position of the indicator; and
transmitting, by a transmitter, data indicative of the rotational position of the indicator.

23. A method according to claim 22, further comprising:
transmitting, by the transmitter, an alarm signal indicating a loose nut condition if the detected rotational position of the indicator exceeds a threshold.

24. A method according to claim 22, wherein the detector is configured to detect a change in rotational position of the indicator, and wherein the method further comprises:
transmitting, by the transmitter, an alarm signal indicating a loose nut condition if the detected change in rotational position of the indicator exceeds a threshold, or
transmitting, by the transmitter, an alarm signal indication a loose nut condition if the detected change in rotational position of the indicator exceeds a thresh, and wherein detecting the rotational position of the indicator comprises sensing, by a sensor, a property of an actuator indicative of relative direction and/or range of the actuator from the detector.

25. (canceled)

26. (canceled)

27. (canceled)

28. (canceled)
